(19) United States
(12) Patent Application Publication
(10) Pub. No.: US 2022/0188295 A1
(43) Pub. Date: Jun. 16, 2022

(54) DYNAMIC MANAGEMENT OF BLOCKCHAIN RESOURCES

(71) Applicant: International Business Machines Corporation, Armonk, NY (US)

(72) Inventors: Petr Novotny, Mount Kisco, NY (US); Qi Zhang, West Harrison, NY (US); Lei Yu, SLEEPY HOLLOW, NY (US); Nitin Gaur, Round Rock, TX (US)

(21) Appl. No.: 17/120,603

(22) Filed: Dec. 14, 2020

(51) Int. Cl. G06F 16/23

(52) U.S. Cl. CPC G06F 16/2379; H04L 67/10; G06F 16/2365

(57) ABSTRACT

A processor may define an available resource set in the blockchain network. The available resource set may be the one or more peers. The processor may collect one or more metrics associated with the one or more peers in the blockchain network. The processor may analyze the one or more metrics and may identify a first workload level for the one or more peers. The processor may determine an optimal status for a first particular peer of the one or more peers, based in part on the available resource set and the first workload level. The processor may compare the optimal status to a current status of the first particular peer. The processor may determine if the optimal status and the current status are different. The processor may execute a status change of the first particular peer from the current status to the optimal status.

### BACKGROUND

The present disclosure relates generally to the field of blockchain storage, and more particularly to resource management in blockchain networks.

As blockchain networks gain popularity, so too has the need to scale these blockchain networks to accommodate the increase in the blockchain network's use. Despite blockchain networks often having static structures, peer workloads can be dynamic, requiring peer resources to fluctuate between underutilization to overutilization. Preparing for overutilization periods can lead to a high total cost of operation resulting in the excess cost and resource waste, particularly during periods of resource underutilization. As such, identifying potential resource management methods while ensuring adequate resources are available, is critical.

### SUMMARY

Embodiments of the present disclosure include a method, system, and computer program product to scale one or more peers a blockchain network. A processor may define an available resource set in the blockchain network. In embodiments, the available resource set may be the one or more peers. The processor may collect one or more metrics associated with the one or more peers in the blockchain network. The processor may analyze the one or more metrics and may identify a first workload level for the one or more peers. The processor may determine an optimal status for a first particular peer of the one or more peers, based in part on the available resource set and the first workload level. The processor may compare the optimal status to a current status of the first particular peer. The processor may determine if the optimal status and the current status are different. The processor may execute a status change of the first particular peer from the current status to the optimal status.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A illustrates an example blockchain architecture, in accordance with embodiments of the present disclosure.

FIG. 1B illustrates a blockchain transactional flow, in accordance with embodiments of the present disclosure.

FIG. 2 depicts an example blockchain network configured to scale one or more peers in a blockchain network, in accordance with embodiments of the present disclosure.

FIG. 3 illustrates a flowchart of an example method for scaling one or more peers in a blockchain network, in accordance with embodiments of the present disclosure.

FIG. 4A illustrates a cloud computing environment, in accordance with embodiments of the present disclosure.

FIG. 4B illustrates abstraction model layers, in accordance with embodiments of the present disclosure.

FIG. 5 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relates generally to the field of blockchain storage, and more particularly to resource management in blockchain networks.

Generally, blockchain networks have a static structure that cannot be easily scaled to dynamically increase or decrease (e.g., scale up or scale down) the resources available to the blockchain network. As discussed herein, blockchain networks can be comprised of blockchain entities (e.g., organizations) comprised of peers. One or more peers may be housed within each entity and configured to have one or more roles (e.g., endorser and/or committer). Due to the single source of proof some blockchain networks often have, special care must be taken to ensure blockchain ledger integrity is maintained among peers.

In embodiments, such as some private blockchain network configurations, each blockchain entity (e.g., organization or stockholder) may have a fixed number of peers. Because of the specialized functions and roles peers provide, if an entity requires additional peers (e.g., for processing a high number of transactions), such peers cannot easily be added to the blockchain network. A peer or entity that does not have sufficient resources, can result in delays with transaction processing that can potentially lead to increased issues, such as increased delays between endorsing and committing stages. These issues and others can significantly inhibit how a client successfully interacts with the blockchain network. As such, business entities often attempt to have enough peers and resources to perform blockchain operations during high transaction processing where the workload of the blockchain entity is high.

While the necessary resources available for blockchain entities and/or peers to perform with/at a high workload (e.g., a workload approaching or exceeding overload) allow the blockchain entity to perform such processing, often the workload is dynamic and can fluctuate between high workloads and low workloads, where the resources of the peer or blockchain entity are underutilized. In traditional systems, maintaining the ability to process high workloads can result in significant resource waste, particularly during low workloads. This resource waste results from the blockchain entity or peer having the resource available regardless of utilization. Ensuring the various resources are available at any time, particularly during low workload periods when the resources are currently in use, can also result in a high total cost of operation.

As such, a method of managing peers and the blockchain entity resources, that allows for resources (e.g., peers) to be auto-scaled to match the current workload while maintain integrity in the blockchain ledger, is paramount. Methods and embodiments discussed herein can generally monitor the workload in a blockchain entity and manage a status of the one or more peers in the blockchain entity (e.g., stop, start, syncing, running, and paused) to sufficiently provide resources to process the workload while minimizing resource waste and the unnecessary cost associated with resource waste.

It will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Detailed herein is a method, system, and computer program product that allow for scaling of one or more peers in a blockchain network while maintaining data integrity and trust among entities in the blockchain network itself. Continuing trust in the blockchain network is possible because, as discussed herein, care is taken to ensure each peer is able to maintain the blockchain/ledger despite a change in status.

In some embodiments, the method, system, and/or computer program product utilize a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency.

In various embodiments, a permissioned and/or a permission-less blockchain can be used. In a public or permission-less blockchain, anyone can participate without a specific identity (e.g., retaining anonymity). Public blockchains can involve native cryptocurrency and use consensus based on various protocols such as Proof of Work. On the other hand, a permissioned blockchain database provides secure interactions among a group of entities which share a common goal, but which do not fully trust one another, such as businesses that exchange funds, goods, (private) information, and the like.

Further, in some embodiments, the method, system, and/or computer program product can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The method, system, and/or computer program product can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded.

An endorsement policy allows chaincode to specify endorsers for a transaction in the form of a set of peer nodes that are necessary for endorsement. When a client sends the transaction to the peers specified in the endorsement policy, the transaction is executed by the peers, which generate speculative transaction results. If enough peers to satisfy the endorsement policy produce identical execution results, the transaction is considered endorsed. After endorsement, the transactions enter an ordering phase in which a consensus protocol is used to produce an ordered sequence of endorsed transactions grouped into blocks. Traditionally used consensus protocols include first-in first-out (FIFO), and leader and follower protocols (e.g., Crash fault tolerance protocols).

In some embodiments, the method, system, and/or computer program product can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., orderer node).

Another type of node is a peer node which can receive ordered client submitted transactions (e.g., from ordering service), commit the transactions and maintain a state and a copy of the ledger of blockchain transactions. Peers can also have the role of an endorser, although it is not a requirement. An ordering-service-node or orderer is a node running an ordering service, which receives a stream of endorsed transactions from clients and emits a stream of ordered transactions. An ordering service node runs a communication service for all peer nodes, and implements a delivery guarantee, such as a broadcast to each of the peer nodes in the system when committing/confirming transactions and modifying a world state of the blockchain, which is another name for the initial blockchain transaction which normally includes control and setup information.

In some embodiment, the method, system, and/or computer program product can utilize a ledger that is a sequenced, tamper-resistant record of all state transitions of a blockchain. State transitions may result from chaincode invocations (e.g., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain.

In some embodiment, the method, system, and/or computer program product described herein can utilize a chain that is a transaction log that is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (e.g., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Blockchain is different from a traditional database in that blockchain is not a central storage, but rather a decentralized, immutable, and secure storage, where nodes may share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the system described herein is implemented due to immutable accountability, security, privacy, permitted decentralization, availability of smart contracts, endorsements and accessibility that are inherent and unique to blockchain.

In particular, the blockchain ledger data is immutable and that provides for an efficient method for scaling one or more peers in a blockchain network. Also, use of the encryption in the blockchain provides security and builds trust. The smart contract manages the state of the asset to complete the life-cycle. The example blockchains are permission decentralized. Thus, each end user may have its own ledger copy to access. Multiple organizations (and peers) may be on-boarded on the blockchain network. The key organizations may serve as endorsing peers to validate the smart contract execution results, read-set and write-set.

One of the benefits of the example embodiments is that it improves the functionality of a computing system by implementing a method for scaling one or more peers in a blockchain network. Through the blockchain system described herein, computing system (or a processor in the computing system) can perform functionality for scaling one or more peers of one or more entities within a blockchain network received from one or more client applications utilizing blockchain networks by providing access to capabilities such as distributed ledger, peers, encryption technologies, MSP, event handling, etc. Also, the blockchain enables to create a business network and make any users or organizations to on-board for participation. As such, the blockchain is not just a database. The blockchain comes with capabilities to create a network of users and on-board/off-board organizations to collaborate and execute service processes in the form of smart contracts (which may be associated with one or more assets).

The example embodiments provide numerous benefits over a traditional database. For example, through the blockchain the embodiments provide for immutable accountability, security, privacy, permitted decentralization, availability of smart contracts, endorsements and accessibility that are inherent and unique to the blockchain.

A traditional database could not be used to implement the example embodiments because it does not bring all parties on the network, it does not create trusted collaboration, and does not provide for an efficient storage of assets. The traditional database does not provide for a tamper proof storage and cannot provide scaling of one or more peers in a blockchain network. As a result, the proposed embodiments described herein utilizing blockchain networks cannot be implemented in the traditional database.

If a traditional database were to be used to implement the example embodiments, the example embodiments would have suffered from unnecessary drawbacks such as search capability, lack of security and slow speed of transactions. Accordingly, the example embodiments provide for a specific solution to a problem in the arts/field of scaling one or more peers in a blockchain network.

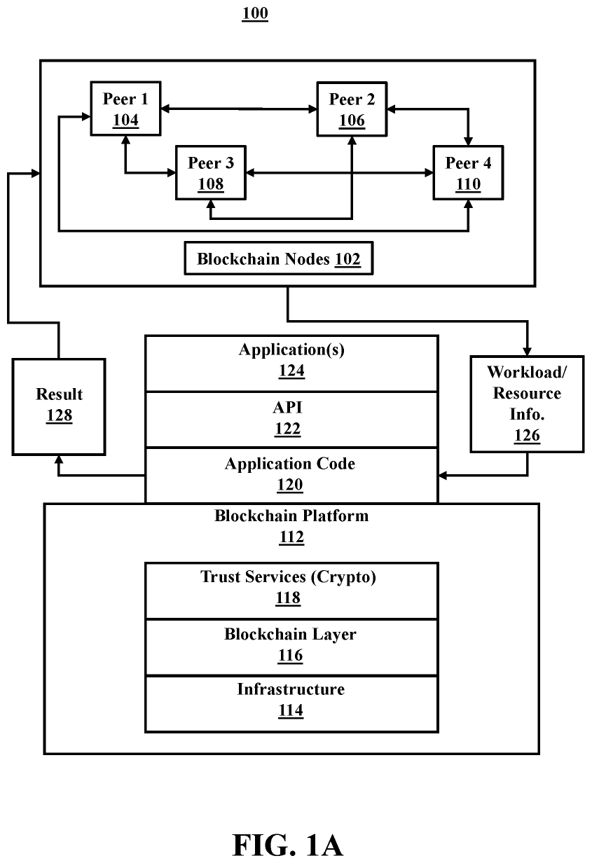

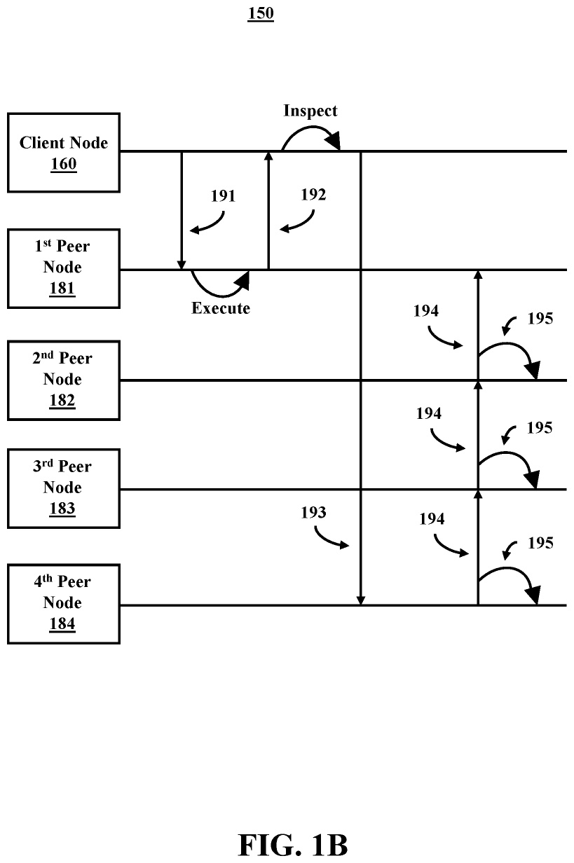

Turning now to FIG. 1A, illustrated is a blockchain architecture 100, in accordance with embodiments of the present disclosure. In some embodiments, the blockchain architecture 100 may include certain blockchain elements, for example, a group of blockchain nodes 102. The blockchain nodes 102 may include one or more blockchain nodes, e.g., peers 104-110 (these four nodes are depicted by example only). These nodes participate in a number of activities, such as a blockchain transaction addition and validation process (consensus). One or more of the peers 104-110 may endorse and/or recommend transactions based on an endorsement policy and may provide an ordering service for all blockchain nodes 102 in the blockchain architecture 100. A blockchain node may initiate a blockchain authentication and seek to write to a blockchain immutable ledger stored in blockchain layer 116, a copy of which may also be stored on the underpinning physical infrastructure 114. The blockchain configuration may include one or more applications 124 which are linked to application programming interfaces (APIs) 122 to access and execute stored program/application code 120 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 104-110.

The blockchain base or platform 112 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 116 may expose an interface that provides access to the virtual execution environment necessary to process the program code and engage the physical infrastructure 114. Cryptographic trust services 118 may be used to verify transactions such as asset exchange transactions and keep information private.

The blockchain architecture 100 of FIG. 1A may process and execute program/application code 120 via one or more interfaces exposed, and services provided, by blockchain platform 112. The code 120 may control blockchain assets. For example, the code 120 can store and transfer data, and may be executed by peers 104-110 in the form of a smart contract and associated chaincode with conditions or other code elements subject to its execution. As a non-limiting example, smart contracts may be created to execute the transfer of resources, the generation of resources, etc. The smart contracts can themselves be used to identify rules associated with authorization and access requirements and usage of the ledger. For example, the workload/resource information 126 may be processed by one or more processing entities (e.g., virtual machines) included in the blockchain layer 116. The result 128 may include a plurality of linked shared documents (e.g., with each linked shared document recording the issuance of a smart contract in regard to the workload/resource information 126, etc.). The physical infrastructure 114 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details (e.g., thus confirming the group of transactions, identifying a conflict between one or more of the transactions in the group of transactions, etc.).

FIG. 1B illustrates an example of a conventional blockchain transactional flow 150 between nodes of the blockchain in accordance with an example embodiment. Referring to FIG. 1B, the transaction flow may include a transaction proposal 191 sent by an application client node 160 to one or more endorsing peer nodes 181 (e.g., in some embodiments, the transaction proposal 191 may be a transaction verification request and/or a conflict verification request). The endorsing peer 181 may verify the client signature and execute a chaincode function to initiate the transaction. The output may include the chaincode results, a set of key/value versions that were read in the chaincode (read set), and the set of keys/values that were written in chaincode (write set). The proposal response 192 is sent back to the client 160 along with an endorsement signature, if approved. The client 160 assembles the endorsements into a transaction payload 193 and broadcasts it to an ordering service node 184. The ordering service node 184 then delivers ordered transactions as blocks to all peers 181-183 on a channel. Before committal to the blockchain, each peer 181-183 may validate the transaction. For example, the peers may check the endorsement policy to ensure that the correct allotment of the specified peers have signed the results and authenticated the signatures against the transaction payload 193.

Referring again to FIG. 1B, the client node 160 initiates the transaction 191 by constructing and sending a request to the peer node 181, which is an endorser. The client 160 may include an application leveraging a supported software development kit (SDK), which utilizes an available API to generate a transaction proposal 191. The proposal is a request to invoke a chaincode function so that data can be read and/or written to the ledger (e.g., write new key value pairs for the assets). The SDK may reduce the package of the transaction proposal 191 into a properly architected format (e.g., protocol buffer over a remote procedure call (RPC)) and take the client's cryptographic credentials to produce a unique signature for the transaction proposal 191.

In response, the endorsing peer node 181 may verify (a) that the transaction proposal 191 is well formed, (b) the transaction has not been submitted already in the past (replay-attack protection), (c) the signature is valid, and (d) that the submitter (client 160, in the example) is properly authorized to perform the proposed operation on that channel. The endorsing peer node 181 may take the transaction proposal 191 inputs as arguments to the invoked chaincode function. The chaincode is then executed against a current state database to produce transaction results including a response value, read-set, and write-set. However, no updates are made to the ledger at this point. In some embodiments, the set of values, along with the endorsing peer node's 181 signature is passed back as a proposal response 192 to the SDK of the client 160 which parses the payload for the application to consume.

In response, the application of the client 160 inspects/verifies the endorsing peers' signatures and compares the proposal responses to determine if the proposal response is the same. If the chaincode only queried the ledger, the application would inspect the query response and would typically not submit the transaction to the ordering node service 184. If the client application intends to submit the transaction to the ordering node service 184 to update the ledger, the application determines if the specified endorsement policy has been fulfilled before submitting (e.g., has a transaction verification request been accepted). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 193 the client 160 assembles endorsements into a transaction and broadcasts the transaction proposal 191 and response within a transaction message to the ordering node 184. The transaction may contain the read/write sets, the endorsing peers' signatures and a channel ID. The ordering node 184 does not need to inspect the entire content of a transaction in order to perform its operation, instead the ordering node 184 may simply receive transactions from all channels in the network, order them by channel, and create blocks of transactions per channel.

The blocks of the transaction are delivered from the ordering node 184 to all peer nodes 181-183 on the channel. The transactions 194 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 195 each peer node 181-183 appends the block to the channel's chain, and for each valid transaction the write sets are committed to current state database. An event is emitted, to notify the client application that the transaction (invocation) has been immutably appended to the chain, as well as to notify whether the transaction was validated or invalidated. Validated transaction and their associated values update the blockchain ledger, while invalidated transactions are committed but the invalidated transaction values do not update the blockchain ledger.

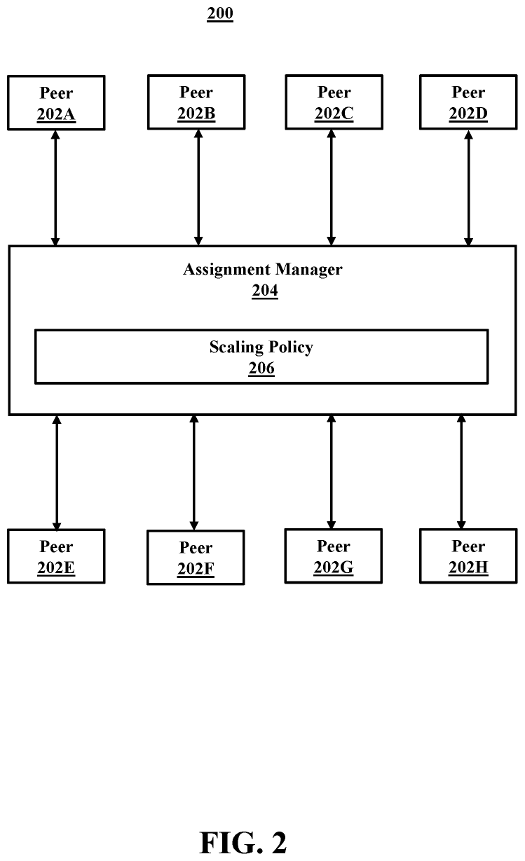

Turning to FIG. 2, illustrated is an example blockchain network 200 for scaling resources (e.g., one or more peers 202A-H) in the blockchain network 200, in accordance with embodiments of the present disclosure. While embodiments disclosed herein often refer to the blockchain network 200 as a permissioned blockchain consortium (e.g., Hyperledger Fabric blockchain network), blockchain network 200 can be configured to work within any type of blockchain consortium (e.g., permissionless blockchain) having peer nodes or nodes providing similar role functions. In embodiments, blockchain network 200 can include one or more blockchain entities (e.g., an organization, etc.) having one or more peers 202A-H configured to perform blockchain functions and an assignment manager 204.

As discussed herein, each of the one or more entities of the blockchain network 200 can include one or more peer nodes 202A-H that may be configured to provide one or more roles in blockchain network 200. These roles include, but are not limited to endorsing (e.g., endorsers) and committing (e.g., committers). While in some embodiments, one or more peers 202A-H may include all of the peers in blockchain network 200, in other embodiments, one or more peers 202A-H may refer to the peers in/of a particular blockchain entity, or to the peers within a particular peer category. Blockchain network 200 may include one or more blockchain entities that include the one or more peers 202A-H. In some embodiments, while a blockchain entity might be configured the same as another blockchain entity in blockchain network 200, in other embodiments, a blockchain entity can differ from other blockchain entities in a variety of ways including, but not limited to the number of peers, available physical resources (e.g., available resource set), and workload the particular blockchain entity may receive.

In embodiments, blockchain network 200 may be configured to include the assignment manager 204. While in some embodiments assignment manager 204 may be configured to provide services and functions discussed herein to all blockchain entities in blockchain network 200, in other embodiments, assignment manager 204 may be specific to a particular blockchain entity, having one or more peers 202A-H. In embodiments, assignment manager 204 can manage and auto-scale one or more peers 202A-H and/or other resources in blockchain network 200. Such auto-scaling can ensure that a sufficient or an optimal amount of resources are utilized during a particular workload level. While reference is made to one or more resources being added and subtracted/removed, such addition or subtraction of resources is often generated by one or more status changes associated with the resource (e.g., running, stopped, synced, etc.).

Resources may include, but are not limited to one or more peers 202A-H and other computing resources, such as CPUs and other electronic hardware. Because of the dynamic workload observed in many blockchain networks, assignment manager 204 can be configured to respond to varying workload levels by adding available resources (e.g., scaling-up) and removing underutilized resources (e.g., scaling-down), to ensure an optimal amount of resources are available for a particular workload level at any given time. For example, assignment manager 204 can allow for more resources to be made available during periods of high workload levels (e.g., endorsing/committing a high number of transactions).

In embodiments, assignment manager 204 may alternatively be configured to reduce the amount of resources during periods of low workload levels when the amount of resources exceeds the amount of processing required. In these embodiments, assignment manager 204 cannot only minimize the amount of resource waste and the cost resulting from resource waste, but also maintaining the integrity of the blockchain (e.g., when a particular peer has a stopped status). In these embodiments, assignment management 204 can provide auto-scaling of one or more peers 202A-H associated with a blockchain entity using an intelligent optimization mechanism configured in/by scaling policy 206.

In embodiments, assignment manager 204 can define an available resource set in blockchain network 200. An available resource set may include one or more peers 202A-H and/or other computing resources (e.g., CPUs or other electronic hardware). In embodiments, the available resource set refers to the total amount of resources that are available to a particular peer (e.g., of a peer category) or blockchain entity. In some embodiments, assignment manager 204 may identify one or more peers 202A-H as a particular peer category (e.g., using scaling policy 206). In some embodiments, different peer categories can have one or more different available resource sets. In some embodiments, assignment manager 204 can identify one or more peer categories from one or more peers 202A-H in blockchain entity or blockchain network 200. A peer category may refer to a group of peers, having at least one peer, from one or more peers 202A-H that have similar characteristics, such as a performing a particular function or having a specific level of access. More particularly, peer categories may have similar characteristics including, but not limited to, peers participating in other ledgers (such as those required for cross ledger verification), peers having access to internal or external system (such as that needed for external verification), and/or types of peers associated with design and/or function of endorsement policies.

As referenced herein, different peer categories can have one or more different available resource sets. In embodiments, scaling policy 206 may define what available resource set is available to a particular peer category. For example, scaling policy 206 can include a sub-policy that indicates when assignment manager 204 observes a particular peer category (e.g., having one or more peers 202A-H) having a heavy workload level, where the majority of the resources are utilized and overloaded, that assignment manager 204 should scale-up either vertically (e.g., increasing the number of CPUs and using the same number of peers) and/or horizontally (e.g., increasing the number of peers available to process the workload). While not all peers of one or more peers 202A-H may belong to a peer category, each peer category may only contain one peer type. In embodiments, scaling policy 206 can be generated by an operator (e.g., of a blockchain entity), how the scaling policy is generated may differ depending on the configuration of blockchain network 200 (e.g., permissioned or permissionless).

In embodiments, scaling policy 206 may control how assignment manager 204 via optimization mechanisms scales a peer (e.g., of one or more peers 202A-H) or peer category (e.g., having a particular peer) when a workload level dynamically changes. As referenced herein, scaling policy can provide sub-policies or rules regarding horizontal scaling and/or vertical scaling options when assignment manager 204 determines scaling (e.g., scaling-up or scaling-down) is beneficial. In embodiments, scaling policy 206 can dictate how assignment manager 204 performs scaling. For example, scaling policy 206 can include a sub-policy that states for a particular peer category, assignment manager 204 should first scale vertically by adding the number of CPUs to aid in processing the workload.

Continuing this example, if assignment manager 204 determines that the workload level of the peer category is still high and/or still overloaded, scaling policy 206 may then have a sub-policy that recommends or requires horizontal scaling, by making one or more additional peers (e.g., belonging to the same peer category) available to process the workload. Alternatively, in some embodiments, scaling policy 206 may recommend to assignment manager 204 to scale-up/down using horizontal methods and vertical methods simultaneously. For example, in some scaling situations, scaling policy 206 can recommend/require assignment manager 204 to provide some additional CPUs and one or two peers to aid in managing the workload.

In embodiments, scaling policy 206 may be based at least in part on a cost-benefit analysis. For example, if the cost associated with initiating (e.g., making available) one or more peers is greater than or less than increasing the number of CPUs, scaling policy 206 may recommend/require assignment manager 204 to choose the least costly resource configuration. In other embodiments, scaling policy 206 may be based on the workload level and amount of overload. For example, if assignment manager detects a significant overloaded workload level, scaling policy 206 could provide sub-policies that respond directly to the particular situation by requiring assignment manager 204 to make a significant portion of, or all of the resources defined in an available resource set, to address the overloaded workload level. As referenced herein, blockchain entities in blockchain network 200 can have different workloads. In some embodiments, scaling policy 206 can be configured to include sub-policies or protocols that can address specific scenarios, such as detected patterns observed overtime in workload levels, that a blockchain entity may commonly encounter.

In embodiments, scaling policy 206 may include additional information, such as what horizontal scaling resources are available and the minimum and maximum number of horizontal scaling resources available. For example, scaling policy 206 may include the total number additional peers that may be added or subtracted to address workload requirements. A minimum number of horizontal scaling resources are often necessary, even during significantly low workload levels, to ensure the ledger is maintained and updated. Because of the requirements peers often must meet in order maintain trust in blockchain network 200, peers cannot often be easily added to the blockchain entity. As such, a maximum number of horizontal scaling resources may be estimated based on expected workload levels.

As contemplated herein, scaling policy 206 may provide the minimum and maximum bounds for vertical scaling resources and horizontal scaling resources that may be specific to a particular peer category. In addition, scaling policy 206 can include if some resources can be used for more than one peer category. For example, in some embodiments, scaling policy 206 may include providing a vertical scaling resource, such as a particular number of CPUs, that can be used for more than peer category.

In embodiments, scaling policy 206 may include additional information, such as the type of vertical scaling resources available and the minimum and maximum number of vertical scaling resources available. For example, scaling policy 206 may include the total number additional CPU's that are available to be added or subtracted to address workload requirements. In embodiments, a minimum number of vertical scaling resources can be the minimum components that are necessary for one or more peers 202A-H in blockchain entity to maintain and ensure trust in the ledger among blockchain entities in blockchain network 200. In embodiments, the maximum number of vertical scaling resources, may be increased by incorporating more hardware. As such, if additional hardware and/or CPUs are added to the maximum vertical scaling resource bound, then scaling policy 206 should also be updated.

As contemplated herein, assignment manager 204 may be configured to monitor one or more peers 202A-H and dynamically manage the level of available resources to reflect changes in the workload level of one or more peers 202A-H (e.g., of one or more different peer categories). In embodiments, assignment manager 204 may be configured to collect one or more metrics associated with each of one or more peers 202A-H (e.g., of a particular peer category). These metrics may include, but are not limited to, the number and/or type of transactions processed by a peer during a particular period of time, the amount of resources currently utilized by the peer (e.g., CPU utilization), and/or the block distribution delay that can be collected from a peer by determining the ledger height (e.g., most recently committed block). In some embodiments, assignment manager 204 can be configured to continuously detect/monitor (e.g., surmount analysis) the workload level of one or more peers 202A-H. While in some embodiments, assignment manager 204 may be configured to detect/monitor each peer category separately, in other embodiments, assignment manager 204 may only detect/monitor fewer than all of the peer categories previously defined.

In embodiments, assignment manager 204 may be configured to analyze the one or more metrics collected to identify a first workload level (e.g., initial workload) for one or more peers 202A-H. For example, assignment manager 204 may analyze the one or more metrics and determine one or more peers 202A-H (e.g., one or more peers belonging to a particular peer category) processing a large batch of transaction has a CPU utilization of 95%. In this example, assignment manager 204 can identify that one or more peers 202A-H has a heavy first workload level. Assignment manager 204 may determine that one or more peers 202A-H has a heavy workload level by comparing the identified workload level to a determined optimal workload level. In embodiments, an optimal workload level may indicate a workload level that one or more peers 202A-H can perform at peak, or near peak processing capabilities. A heavy workload level may indicate that one or more peers 202A-H (e.g., or peers belonging to a particular peer category) are overloaded (e.g., with a large transaction batch) and unable to timely process the workload. In embodiments, assignment manager 204 may be configured to determine an optimal status for a first particular peer (e.g., peer 202A of one or more peers 202A-H). In these embodiments, the optimal status for the first particular peer may be based, at least in part, on the available resource set and the first workload level.

For example, a first particular peer may belong to a particular peer category having one or more peers 202A-H that are part of an available resource set. In embodiments, an optimal status may be defined for each peer, including first particular peer, associated with the available resource set of a peer category. As contemplated herein, there may be a minimum and maximum number of peers associated with an available resource set that may be used to process a workload (e.g., as defined in scaling policy 206). In embodiments, assignment manager 204 may compare the first workload level to an optimal workload level to determine if all or fewer than all of the one or more peers 202A-H (e.g., including a first particular peer) in an available resource set associated with a particular peer category are needed to process the first workload level. In embodiments where assignment manager 204 may determine an optimal status for each of the one or more peers 202A-H depending on whether each particular peer is needed in some way to process the first workload level.

In embodiments, each of the one or more peers 202A-H may have a particular status. These statuses may include, but are not limited to, a “stopped status”, “starting status,” “syncing status,” “running status,” “paused status,” and “standby status.” While reference is often made herein regarding peers having status changes, other resources, such as a vertical scaling resources (e.g., CPUs), may also have status changes (e.g., “on status” or “off status”). In embodiments, a “stopped status” may refer to the peer service and associated container being stopped. In these embodiments, a “stopped status” can refer to the peer is not being connected to a channel and the peer is not ledger syncing processes or updating the blockchain ledger. However, in embodiments, despite a peer having a “stopped status” the peer may be configured to receive and respond to a request to start and, responsive to receiving such a request, change to a starting status. In embodiments, a “starting status” can indicate the peer service is running. In these embodiments, while a “starting status” can indicate that the peer is connected to a channel, the peer may be downloading ledger changes and performing necessary ledger syncing processes (e.g., after having a stopped status for a duration of time), and may not be processing transactions. In embodiments, a “synced status” can indicate the peer service is running, but is not processing transactions (e.g., committing/committer). In these embodiments, a “synced status” can also indicate that the peer is connected to a channel and performing ledger syncing processes. In embodiments, a “running status” can indicate that a peer is running, and performing some or all transaction processing (e.g., endorsing/endorser), ledger syncing processes, and that the peer is connected to a channel. In embodiments, a “paused status” can refer to the container (e.g., virtual machine) being instantiated by the peer service is not running (e.g., is paused) and it is not connected to a channel and ledger syncing processes are halted. In embodiments, a “standby status” can refer to a transition status that can act as an intermediate state between particular statuses that can allow for a running peer to easily and seamlessly move between status changes without error or issue. While in some embodiments, a “standby status” could be configured to act as an intermediate state between “stopping status” and “running status” and/or between “starting status” and “running status.” In such examples, the peer may be partially or completely functioning, but not yet available to clients. In embodiments, “standby status” may allow a peer to have better control over a peer's status changes.

In embodiments, a particular peer (e.g., first particular peer) can cycle through the aforementioned statuses as needed (e.g., depending on the workload level) to minimize the number and amount of resources wasted. For example, a particular peer category of a blockchain entity may have an available resource set having five peers. In this particular example, the blockchain entity may receive a medium sized batch of transactions to process. If one peer has a “running status” and the four remaining peers have a “stopped status,” the one peer used to process the medium sized batch of transactions is likely to be considered overloaded. In such an embodiment, assignment manager 204 may identify or determine that the first workload level is heavy and the peer having the “running status” is currently overutilized. In this example embodiment, assignment manager 204 may determine (e.g., via scaling policy 206) the optimal status for each of the five peers. For example, the optimal status for three of the peers may be a “running status” while the optimal status for the remaining two peers may be a “stopped status.” Processing delays caused by overloading a resource could result in reducing the utility of the blockchain by increasing the time delay between endorsement and committing a transaction to the blockchain. Such time delays could result in an increase in state violations and minimize the number of transactions considered valid during the validation phase (e.g., in Hyper-Ledger Fabric).

In embodiments, assignment manager 204 may be configured to compare the optimal status to a current status of the first particular peer. In these embodiments, a current status refers to the status a particular peer has at the time the first workload level was identified. In an example embodiment, a blockchain entity may have five peers (e.g., Peer A, Peer B, Peer C, Peer D, and Peer E) to process a medium sized batch of transactions. In this example embodiments, Peer A could have a “running status” as a current state, while Peer B, Peer C, Peer D, and Peer E could each have a “stopped status” as their respective current statuses. In this example embodiment, assignment manager 204 could identify that Peer A is overloaded and that the first workload level is high or heavy. Assignment manager 204 may further determine that in order to satisfy the optimal workload level needed to adequately process the medium sized batch of transactions requires the use of three peers having a “running status” and two peers having a “stopped status.” In this example embodiments, assignment manager 204 can compare a particular peer's current status (e.g., current status of Peer A) to the determined optimal status of the same peer.

In embodiments, assignment manager 204 may be configured to determining if the optimal status and the current status of the first particular peer are different. Continuing the above example embodiment, if the first particular peer is Peer A, then assignment manager 204 can compare the current status of Peer A to the optimal status of Peer A. In this particular example, the current status of Peer A is “running status” and the determined optimal status is “running status.” Assignment manager 204 can determine that the two statuses are the same and as a result, no status change is necessary for Peer A. Alternatively, if a first particular peer is Peer B then assignment manager 204 can compare the current status of Peer B to the optimal status of Peer B. In this particular example, the current status of Peer B is “stopped status” and the determined optimal status is “running status.” Assignment manager 204 can compare the two statuses and determine that they are different.

In embodiments, assignment manager 204 may be configured to execute, responsive to determining the optimal status and the current status are different, a status change of the first particular peer from the current status to the optimal status. Continuing the most recent example, when assignment manager 204 determines that the current status and optimal status of Peer B are different, assignment manager 204 can interact with the first particular peer (e.g., Peer B) and associated container to execute the status change from “stopped status” to “running status.”

In embodiments, assignment manager 204 may continue to collect one or more metrics associated with one or more peers 202A-H. In these embodiments, during this continued collection assignment manage 204 can detect a change in the one or more metrics and determine a second workload level. While in some embodiments, the first workload level and the second workload level are the same, in other embodiments, first workload level and second workload level are different and can represent a dynamic change in the workload received by a blockchain entity. In embodiments, assignment manager 204 may be configured to determine a new optimal status for the first particular peer based on the second workload level. As referenced herein, assignment manager 204 may determine the optimal status and a new optimal status using a variety of methods including, but not limited to, one or more algorithms that may define for each peer category or blockchain entity when a status change should occur, and various modeling and/or calculations that consider one or more trends/patterns associated with the workloads received from a blockchain entity. Such methods aim to ensure the workload is process sufficiently without underutilizing or over utilizing the number and status of one or more peers 202A-H. In embodiments, if assignment manager 204 determines that the optimal status (e.g., the status of the first particular peer prior to the change in workload) is different from the new optimal status, assignment manager 204 may execute a second status change from a previous optimal status to the new optimal status. In embodiments, a second status change, or any additional status change, may be executed or similarly configured to the execution of the initial status change.

In embodiments, assignment manager 204 may be configured to determine an optimal status for a second particular peer of a particular peer category having one or more peers 202A-H. In these embodiments, the optimal status of the second particular peer and the optimal status of the first particular peer may be different. In an example embodiment, a blockchain entity can have five peers (e.g., Peer A, Peer B, Peer C, Peer D, and Peer E) associated with an available resource set belonging to a particular peer category. In this example embodiment, the blockchain entity may receive a large batch of transactions to process that requires all five peers to be utilized and have a “running status.” In some embodiments, assignment manager 204 could determine that even though all the resources in an available resource set are utilized (e.g., all five peers in the peer category) that the workload level is high and/or overloaded while processing the large batch of transactions. In these embodiments, assignment manager 204 cannot recommend status changes or the addition of resources if the maximum number and/or amount of resources (e.g., available resource set) has already been utilized.

Continuing the above example embodiment, assignment manager 204 may detect a change in the one or more collected metrics and identify a second workload level. As referenced above, each peer (e.g., Peer A, Peer B, Peer C, Peer D, and Peer E) has a current status of “running status” that was used to process a first workload level. In embodiments, assignment manager 204 can identify a change in the workload between the first workload level (e.g., a heavy workload level) and the second workload level. In these embodiments, assignment manager 204 can also determine the optimal status of each peer associated with the change in workload level. In this example embodiment, assignment manager 204 can determine (e.g., via scope policy 206) that because the second workload level is very low, only the minimum number of peers (e.g., Peer A) required to maintain the blockchain and blockchain entity may be required. As such, Peer B, Peer C, Peer D, and Peer E should undergo a status change (e.g., status change from “running status” to “stopped status”).

In this example embodiments, a first particular peer, such as Peer A (e.g., peer 202A), may have the same current status and the same optimal status. As such, in this example embodiment, the first particular peer will not execute a status change. Continuing this example embodiment, assignment manager 204 may determine second particular peer, such as Peer B (e.g., peer 202B), when the current status (e.g., “running status”) is compared to the optimal status (e.g., “stopped status”) that the current status and the optimal status of the second particular peer are different. In this example embodiment, assignment manager 204 may be configured to execute the status change of the second particular peer from the current status to the optimal status.

In embodiments, assignment manager 204 via scaling policy 206 can execute a status change on a particular peer. While embodiments herein often reference a first particular peer and/or a second particular peer, any peer within an available resource set, as defined in scaling policy 206, may undergo similar or the same processes. In some embodiments, the optimal status for the first particular peer could be identified as a “start status.” While the current status of first particular peer could refer to any status contemplated herein, often the current status is likely a “stopped status” or a “paused status” where many or all of the functions of the peer were halted to conserve resources. In embodiments, first particular peer may be configured to receive a request from assignment manager 204 via scaling policy 206. In these embodiments, once the request is received and the peer service associated with the first particular peer starts, first particular peer may initiate ledger syncing processes (e.g., fast ledger sync) and can begin engaging in block delivery protocols in blockchain network 200. When the first particular peer is determined to be fully functional and has the most recently updated state, one or more notifications can be sent to notify various entities (e.g., clients) in blockchain network 200 of the first particular peer's status change. Such notifications may inform clients or entities that the first particular peer is available to perform endorsing or committing functions.

In some embodiments, assignment manager 204 via scaling policy 206 can execute a status change on a first particular peer where the optimal status of the first particular peer could be identified as a “shutting-down status” or “stopping status.” In these embodiments, assignment manager 204 via scaling policy 206 can provide one or more notifications to one or more entities of blockchain network 200 informing the entities (e.g., clients) of the first particular peer's status change. Such notifications may inform the one or more entities that the first particular peer has a “stopped status” and will not be performing traditional functions and, as such, should not be used by the one or more entities. In some embodiments, prior to receiving a request from assignment manager 204 to shutdown (e.g., via scaling policy 206), the first particular peer may be configured to provide a grace period. In these embodiments, a grace period may refer to a period of time where despite sending a notification to one or more entities of blockchain network 200 that the first particular peer is shutting down, the first particular peer may be configured to respond, or process requests received during the grace period. In these embodiments, after the grace period expires, the first particular peer continues to shutdown (e.g., “stopped status”) and will no longer be able to receive or process requests, except those process requests as they relate to status changes.

In embodiments, once the first particular peer has been shut down, blockchain network 200 may advertise to one or more entities (e.g., clients) the status change and how the status change affects blockchain structure (e.g., discovery services). One or more entities may include one or more clients and/or client devices (e.g., computers connected to a server). In embodiments, one or more entities, such as clients, may receive notice of the new configuration and adjust their communication strategy regarding how the entity interacts with the blockchain ledger and blockchain network 200. Such notification ensures that while blockchain network 200 can reduce resource waste other important considerations, such as the resulting impact on the processing of entity or client transactions, are not negatively affected.

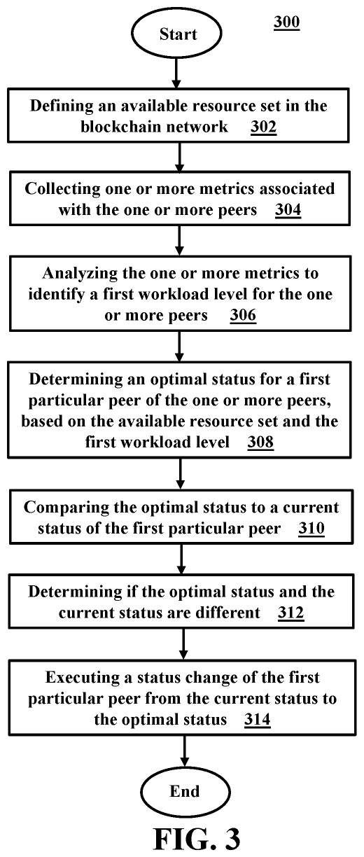

Referring now to FIG. 3, a flowchart illustrating an example method 300 for scaling one or more peers in a blockchain network, in accordance with embodiments of the present disclosure. In some embodiments, the method 300 may be performed by one or more peer nodes within the blockchain network (e.g., blockchain network 200). In some embodiments, the method 300 begins at operation 302 where the processor defines an available resource set in the blockchain network. In some embodiments, the available resource set may be the one or more peers. In some embodiments, the method 300 proceeds to operation 304 where the processor generates an entity policy. The entity policy provides one or more world-state rules associated with a particular entity. In some embodiments, the method 300 proceeds to operation 304 where the processor collects one or more metrics associated with the one or more peers in the blockchain network.

In some embodiments, the method 300 proceeds to operation 306 where the processor analyzes the one or more metrics to identify a first workload level for the one or more peers. In some embodiments, the method 300 proceeds to operation 308. At operation 308, the processor may determine an optimal status for a first particular peer of the one or more peers. In some embodiments, the optimal status may be based in part on the available resource set and the first workload level. In some embodiments, the method 300 proceeds to operation 310.

At operation 310, the processor may compare the optimal status to a current status of the first particular peer. In some embodiments, the method 300 proceeds to operation 312. At operation 312, the processor may determine if the optimal status and the current status are different. In some embodiments, the method 300 proceeds to operation 314.

At operation 314, the processor may execute a status change of the first particular peer from the current status to the optimal status. In some embodiments, this status change may be executed in response to determining the optimal status and the current status are different. In some embodiments, as depicted, after operation 314, method 300 may end.

In some embodiments, discussed below, there are one or more operations of the method 300 not depicted for the sake of brevity with operations/steps further performed by the processor.

In embodiments, the processor may detect a change in the one or metrics associated with the one or more peers. In these embodiments, the processor may determine a second workload level of the one or more peers. The second workload level may be based on the change in the one or more metrics. The processor may then determine a new optimal status for the first particular peer based on the second workload level. In embodiments, the processor may execute a second status change from the previous optimal status to the new optimal status.

In embodiments, executing the status change may include, the processor identifying the optimal status for the first particular peer is a peer “start status”. In some embodiments, the processor may initiate a fast ledger sync of the first particular peer. In these embodiments, the processor may notify the blockchain network of the peer “start status” and start the first particular peer.

In embodiments, executing the status change may include, the processor identifying the optimal status for the first particular peer as a peer shutdown status and notifying the blockchain network of the peer shut down status. In some embodiments, the processor may further notify one or more clients of a new configuration of the blockchain network. In these embodiments, the processor may adjust a network communication strategy for the blockchain network.

In embodiments, notifying the blockchain network of the peer shutdown status may include, the processor providing a grace period. In embodiments, the grace period may refer to a period of time the first particular peer is configured to respond to requests before the first particular peer may be shutdown.

In embodiments, the processor may define a scaling policy for the one or more peers. The scaling policy may include a peer category, scaling bounds, and parameters.

In embodiments, the processor may determine an optimal status for a second particular peer of the one or more peers. In these embodiments, the optimal status of the second particular peer and the optimal status of the first particular peer may be different. In these embodiments, the processor may compare the optimal status of the second particular peer to a current status of the second particular peer. The processor may then determine the optimal status and the current status of the second particular peer may be different. Responsive to determining the optimal status and the current status of the second particular peer are different, the processor may execute the status change of the second particular peer from the current status to the optimal status.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an entity. It may be managed by the entity or a third party and may exist on-premises or off-premises.

Community cloud: the cloud infrastructure is shared by several entities and supports a specific community that has shared concerns (e.g., mission, security requirements, policy, and compliance considerations). It may be managed by the entities or a third party and may exist on-premises or off-premises.

Public cloud: the cloud infrastructure is made available to the general public or a large industry group and is owned by an entity selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

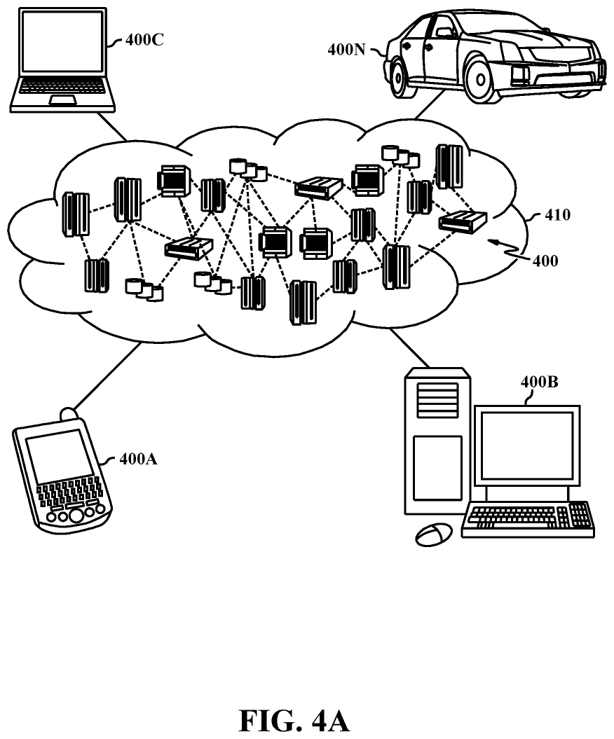

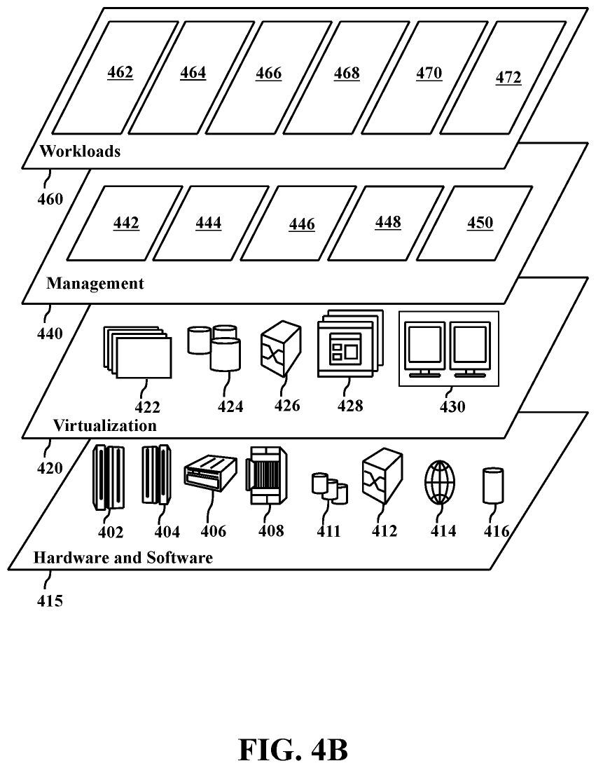

FIG. 4A, illustrated is a cloud computing environment 410 is depicted. As shown, cloud computing environment 410 includes one or more cloud computing nodes 400 with which local computing devices used by cloud consumers, such as, for example, personal digital assistant (PDA) or cellular telephone 400A, desktop computer 400B, laptop computer 400C, and/or automobile computer system 400N may communicate. Nodes 400 may communicate with one another. They may be grouped (not shown) physically or virtually, in one or more networks, such as Private, Community, Public, or Hybrid clouds as described hereinabove, or a combination thereof.

This allows cloud computing environment 410 to offer infrastructure, platforms and/or software as services for which a cloud consumer does not need to maintain resources on a local computing device. It is understood that the types of computing devices 400A-N shown in FIG. 4A are intended to be illustrative only and that computing nodes 400 and cloud computing environment 410 can communicate with any type of computerized device over any type of network and/or network addressable connection (e.g., using a web browser).

FIG. 4B, illustrated is a set of functional abstraction layers provided by cloud computing environment 410 (FIG. 4A) is shown. It should be understood in advance that the components, layers, and functions shown in FIG. 4B are intended to be illustrative only and embodiments of the disclosure are not limited thereto. As depicted below, the following layers and corresponding functions are provided.

Hardware and software layer 415 includes hardware and software components. Examples of hardware components include: mainframes 402; RISC (Reduced Instruction Set Computer) architecture based servers 404; servers 406; blade servers 408; storage devices 411; and networks and networking components 412. In some embodiments, software components include network application server software 414 and database software 416.

Virtualization layer 420 provides an abstraction layer from which the following examples of virtual entities may be provided: virtual servers 422; virtual storage 424; virtual networks 426, including virtual private networks; virtual applications and operating systems 428; and virtual clients 430.

In one example, management layer 440 may provide the functions described below. Resource provisioning 442 provides dynamic procurement of computing resources and other resources that are utilized to perform tasks within the cloud computing environment. Metering and Pricing 444 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 446 provides access to the cloud computing environment for consumers and system administrators. Service level management 448 provides cloud computing resource allocation and management such that required service levels are met. Service Level Agreement (SLA) planning and fulfillment 450 provide pre-arrangement for, and procurement of, cloud computing resources for which a future requirement is anticipated in accordance with an SLA.

Workloads layer 460 provides examples of functionality for which the cloud computing environment may be utilized. Examples of workloads and functions which may be provided from this layer include: mapping and navigation 462; software development and lifecycle management 464; virtual classroom education delivery 466; data analytics processing 468; transaction processing 470; and scaling one or more peers in a blockchain network 472.

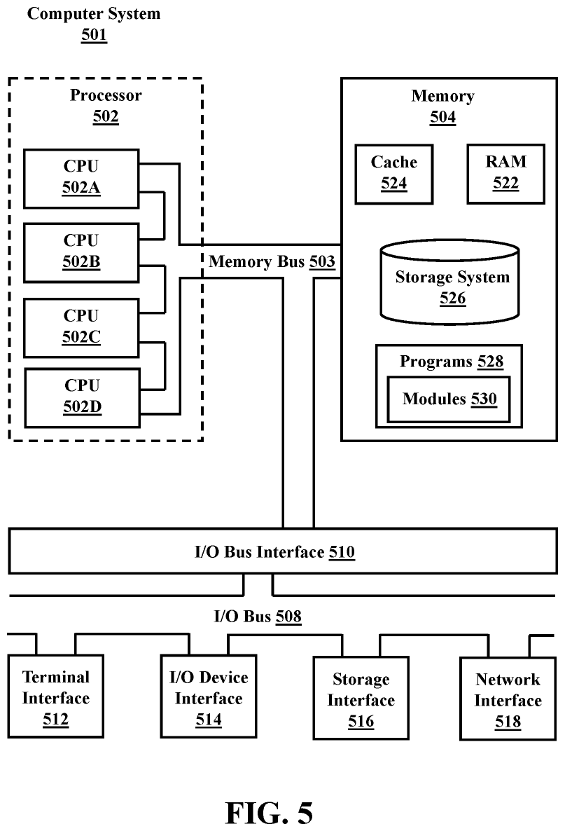

FIG. 5, illustrated is a high-level block diagram of an example computer system 501 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 501 may comprise one or more CPUs 502, a memory subsystem 504, a terminal interface 512, a storage interface 516, an I/O (Input/Output) device interface 514, and a network interface 518, all of which may be communicatively coupled, directly or indirectly, for inter-component communication via a memory bus 503, an I/O bus 508, and an I/O bus interface unit 510.

The computer system 501 may contain one or more general-purpose programmable central processing units (CPUs) 502A, 502B, 502C, and 502D, herein generically referred to as the CPU 502. In some embodiments, the computer system 501 may contain multiple processors typical of a relatively large system; however, in other embodiments the computer system 501 may alternatively be a single CPU system. Each CPU 502 may execute instructions stored in the memory subsystem 504 and may include one or more levels of on-board cache.

System memory 504 may include computer system readable media in the form of volatile memory, such as random access memory (RAM) 522 or cache memory 524. Computer system 501 may further include other removable/non-removable, volatile/non-volatile computer system storage media. By way of example only, storage system 526 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 504 can include flash memory, e.g., a flash memory stick drive or a flash drive. Memory devices can be connected to memory bus 503 by one or more data media interfaces. The memory 504 may include at least one program product having a set (e.g., at least one) of program modules that are configured to carry out the functions of various embodiments.

One or more programs/utilities 528, each having at least one set of program modules 530 may be stored in memory 504. The programs/utilities 528 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 528 and/or program modules 530 generally perform the functions or methodologies of various embodiments.

Although the memory bus 503 is shown in FIG. 5 as a single bus structure providing a direct communication path among the CPUs 502, the memory subsystem 504, and the I/O bus interface 510, the memory bus 503 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 510 and the I/O bus 508 are shown as single respective units, the computer system 501 may, in some embodiments, contain multiple I/O bus interface units 510, multiple I/O buses 508, or both. Further, while multiple I/O interface units are shown, which separate the I/O bus 508 from various communications paths running to the various I/O devices, in other embodiments some or all of the I/O devices may be connected directly to one or more system I/O buses.

In some embodiments, the computer system 501 may be a multi-user mainframe computer system, a single-user system, or a server computer or similar device that has little or no direct user interface, but receives requests from other computer systems (clients). Further, in some embodiments, the computer system 501 may be implemented as a desktop computer, portable computer, laptop or notebook computer, tablet computer, pocket computer, telephone, smartphone, network switches or routers, or any other appropriate type of electronic device.

It is noted that FIG. 5 is intended to depict the representative major components of an exemplary computer system 501. In some embodiments, however, individual components may have greater or lesser complexity than as represented in FIG. 5, components other than or in addition to those shown in FIG. 5 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method to scale one or more peers in a blockchain network, the method comprising:
defining an available resource set in the blockchain network, wherein the available resource set is the one or more peers;
collecting one or more metrics associated with the one or more peers in the blockchain network;
analyzing the one or more metrics to identify a first workload level for the one or more peers;
determining an optimal status for a first particular peer of the one or more peers, based in part on the available resource set and the first workload level;
comparing the optimal status to a current status of the first particular peer;
determining if the optimal status and the current status are different; and
executing, responsive to determining the optimal status and the current status are different, a status change of the first particular peer from the current status to the optimal status.

2. The method of claim 1, further comprising:
detecting a change in the one or more metrics associated with the one or more peers;
determining a second workload level of the one or more peers, wherein the second workload level is based on the change in the one or more metrics;
determining a new optimal status for the first particular peer based on the second workload level; and
executing a second status change from a previous optimal status to the new optimal status.

3. The method of claim 1, wherein executing the status change comprises:
identifying the optimal status for the first particular peer is a peer start status;
initiating a fast ledger sync of the first particular peer;
notifying the blockchain network of the peer start status; and
starting the first particular peer.

4. The method of claim 1, wherein executing the status change comprises:
identifying the optimal status for the first particular peer as a peer shutdown status;
notifying the blockchain network of the peer shut down status;
notifying one or more clients of a new configuration of the blockchain network; and
adjusting a network communication strategy for the blockchain network.

5. The method of claim 4, wherein notifying the blockchain network of the peer shut down status comprises:
providing a grace period wherein the first particular peer is configured to respond to requests; and
shutting down the first particular peer.

6. The method of claim 1, further comprising:
defining a scaling policy for the one or more peers, wherein the scaling policy includes a peer category, scaling bounds, and parameters.

7. The method of claim 1, further comprising:
determining an optimal status for a second particular peer of the one or more peers, wherein the optimal status of the second particular peer and the optimal status of the first particular peer are different.

8. The method of claim 7, further comprising:
comparing the optimal status of the second particular peer to a current status of the second particular peer;
determining the optimal status and the current status of the second particular peer are different; and
executing the status change of the second particular peer from the current status to the optimal status.

9. A system for scaling one or more peers in a blockchain network, the system comprising:
a memory; and
a processor in communication with the memory, the processor being configured to perform operations comprising:
defining an available resource set in the blockchain network, wherein the available resource set is the one or more peers;
collecting one or more metrics associated with the one or more peers in the blockchain network;
analyzing the one or more metrics to identify a first workload level for the one or more peers;
determining an optimal status for a first particular peer of the one or more peers, based in part on the available resource set and the first workload level;
comparing the optimal status to a current status of the first particular peer;
determining if the optimal status and the current status are different; and
executing, responsive to determining the optimal status and the current status are different, a status change of the first particular peer from the current status to the optimal status.

10. The system of claim 9, wherein the operations further comprise:
detecting a change in the one or more metrics associated with the one or more peers;
determining a second workload level of the one or more peers, wherein the second workload level is based on the change in the one or more metrics;
determining a new optimal status for the first particular peer based on the second workload level; and
executing a second status change from a previous optimal status to the new optimal status.

11. The system of claim 9, wherein executing the status change comprises:
identifying the optimal status for the first particular peer is a peer start status;
initiating a fast ledger sync of the first particular peer;
notifying the blockchain network of the peer start status; and
starting the first particular peer.

12. The system of claim 9, wherein executing the status change comprises:
identifying the optimal status for the first particular peer as a peer shutdown status;
notifying the blockchain network of the peer shut down status;
notifying one or more clients of a new configuration of the blockchain network; and
adjusting a network communication strategy for the blockchain network.

13. The system of claim 11, wherein notifying the blockchain network of the peer shut down status comprises:
providing a grace period wherein the first particular peer is configured to respond to requests; and
shutting down the first particular peer.

14. The system of claim 9, wherein the operations further comprise:
defining a scaling policy for the one or more peers, wherein the scaling policy includes a peer category, scaling bounds, and parameters.

15. The system of claim 9, wherein the operations further comprise:
determining an optimal status for a second particular peer of the one or more peers, wherein the optimal status of the second particular peer and the optimal status of the first particular peer are different.

16. The system of claim 14, wherein the operations further comprise:
comparing the optimal status of the second particular peer to a current status of the second particular peer;
determining the optimal status and the current status of the second particular peer are different; and
executing the status change of the second particular peer from the current status to the optimal status.

17. A computer program product for scaling one or more peers in a blockchain network, the computer program product comprising a computer readable storage medium having program instructions embodied therewith, the program instructions executable by a processor to cause the processors to perform a function, the function comprising defining an available resource set in the blockchain network, wherein the available resource set is the one or more peers;
collecting one or more metrics associated with the one or more peers in the blockchain network;
analyzing the one or more metrics to identify a first workload level for the one or more peers;
determining an optimal status for a first particular peer of the one or more peers, based in part on the available resource set and the first workload level;
comparing the optimal status to a current status of the first particular peer;
determining if the optimal status and the current status are different; and
executing, responsive to determining the optimal status and the current status are different, a status change of the first particular peer from the current status to the optimal status.

18. The computer program product of claim 16, wherein the functions further comprise:
detecting a change in the one or more metrics associated with the one or more peers;
determining a second workload level of the one or more peers, wherein the second workload level is based on the change in the one or more metrics;
determining a new optimal status for the first particular peer based on the second workload level; and
executing a second status change from a previous optimal status to the new optimal status.

19. The computer program product of claim 16, wherein executing the status change comprises:
identifying the optimal status for the first particular peer is a peer start status;
initiating a fast ledger sync of the first particular peer;
notifying the blockchain network of the peer start status; and
starting the first particular peer.

20. The computer program product of claim 16, wherein executing the status change comprises:
identifying the optimal status for the first particular peer as a peer shutdown status;
notifying the blockchain network of the peer shut down status;
notifying one or more clients of a new configuration of the blockchain network; and
adjusting a network communication strategy for the blockchain network.
